(19) United States
(12) Patent Application Publication
(10) Pub. No.: US 2008/0090043 A1
(43) Pub. Date: Apr. 17, 2008

(54) Pressure Distribution Pad for Laminating Applications

(76) Inventor: Brian C. Biller, Mentor, OH (US)

Correspondence Address: PATENT GROUP 2N;JONES DAY, NORTH POINT, 901 LAKESIDE AVENUE, CLEVELAND, OH, 44114, US

(21) Appl. No.: 11/859,143

(22) Filed: Sep. 21, 2007

Related U.S. Application Data
(60) Provisional application No. 60/826,443, filed on Sep. 21, 2006.

(51) Int. Cl. B32B 7/06; B32B 7/12

(52) U.S. Cl. 428/41.8; 428/221; 428/332; 428/339

(57) ABSTRACT

A pressure distribution pad for use in laminating applications includes a flexible graphite core that is laminated or coated with a thin film or a fibrous scrim or fabric. The graphite core may be coated on one or both sides. Two or more coatings may be utilized. The pressure distribution pads may be reusable.

### CROSS-REFERENCE TO RELATED APPLICATION

This application claims priority to U.S. Provisional Application No. 60/826,443, filed Sep. 21, 2006, the disclosure of which is incorporated herein by reference in its entirety.

### FIELD

This technology relates to pressure distribution pads for laminating applications. Tn particular, the technology concerns a pressure distribution pad for use in laminating processes for rigid multilayer circuit boards, flexible printed circuit hoards, thin-film heaters, wire wound heaters, and other laminates.

### BACKGROUND

Conventional pressure distribution pads are typically made of rubber or other types of elastomers. Many of them are fiberglass reinforced silicone rubber. Rubber pressure pads creep under pressure, which can cause defects in the laminate. Because rubber pads are thermal insulators, the laminate may heat with less uniformity. Other conventional pressure distribution pads include paper or fiber pads. Conventional pads have problems with uniformity of temperature distribution, operational temperature limitations, and reuse.

One prior art pad, such as the PACOPAD by Pacothane Technologies of Holyoke, Mass., touts several benefits, such as helping to control heat rise, equalizing pressure throughout the pressure load, three-dimensional conformance, and cost-effectiveness. The PACOPAD has a maximum operating temperature of 475 degrees F. (246 degrees C.) for six hours, low moisture to reduce liquid buildup in vacuum systems, uniform fiber formation for pressure equalization, low fiber dusting and contamination, and no resinous binders or fillers. They are made of a cellulosic-based product.

Another prior art pad, such as the Thermapad™ by Arlon Silicone Technologies of Bear, Del., touts the advantages of long life, uniform heat rise, no shedding, dimensional stability, uniform cushioning, and faster layups. The Thermapad™ is made of silicone rubber composites and has a maximum operating temperature of 400 degrees F. (204 degrees C.).

In accordance with the teachings described herein, a pressure distribution pad includes a core of graphite and at least one layer of a coating coupled to the graphite.

### BRIEF DESCRIPTION OF THE DRAWINGS FIGURES

FIG. 1 is an example pressure pad system;

FIG. 2 is a cross-sectional view of an example pressure pad;

FIG. 3 is a cross-sectional view of another example pressure pad;

FIG. 4 is cross-sectional view of yet another example pressure pad;

FIG. 5 is a top view of a test shape used in testing the system;

FIG. 6 is a perspective view of an example pressure pad that has been tested by utilizing the test shape of FIG. 5;

FIG. 7 is an example pressure pad; and

FIG. 8 is a perspective view of the test shape of FIG. 5 being positioned between two pressure pads, such as the pressure pad of FIG. 7, after pressing.

### DETAILED DESCRIPTION

The examples described herein are an improved pressure distribution pad 10 for laminating applications. The example pressure distribution pad 10 includes a flexible graphite core material 12 that may have a thickness from about 0.005″, to about 0.25″ thick. The flexible graphite core 12 is coated or laminated with thin films 14 and/or fibrous scrims/fabrics 14, which will be described in greater detail below. The pressure distribution pads 10 are used in laminating processes for rigid multi-layer circuit boards, flexible printed circuit boards, thin-film heaters, wire would heaters, the like, and any other laminates requiring uniform pressure, or having thickness variations.

The example pad 10 incorporates all the benefits of the prior art pads, as noted in the background section, and comprises further benefits over the prior art. Conventional pressure pads function to provide even pressure to the materials being laminated. If pressure is not even, the laminate produced may be full of air voids, or have insufficient/inconsistent bond strength or a partial bond, among other known problems. Most conventional pressure pads are made from thermal insulators (TC<1 W/m° C.). Conventional pressure pads are typically made of rubber or other types of elastomers. Many of them are fiberglass reinforced silicone rubber. Rubber pressure pads creep under pressure, which can cause defects in the laminate. Creep can easily damage delicate products, such as laminated circuits. Pressure pad creep often forces components in the laminate to move with the pressure pad, which can damage the finished product. Because rubber pads are thermal insulators, the laminate may heat with less uniformity when compared to graphite pressure pads 10. In addition, conventional pressure pads can degrade with exposure to elevated temperatures.

Graphite will not degrade in pressing applications unless exposed to temperatures above 800° F. Because graphite is a conductor, the pad 10 heats more evenly and the laminate 16 heats more quickly. Graphite's properties are not significantly affected in the range of process temperatures typically used in laminating and pressure settings can remain the same regardless of temperature. Graphite pressure pads 10 are capable of operating at higher temperatures than conventional rubber pressure pads. Because graphite does not degrade at the operating temperatures utilized in laminating, the pads 10 may be used multiple times before discarding.

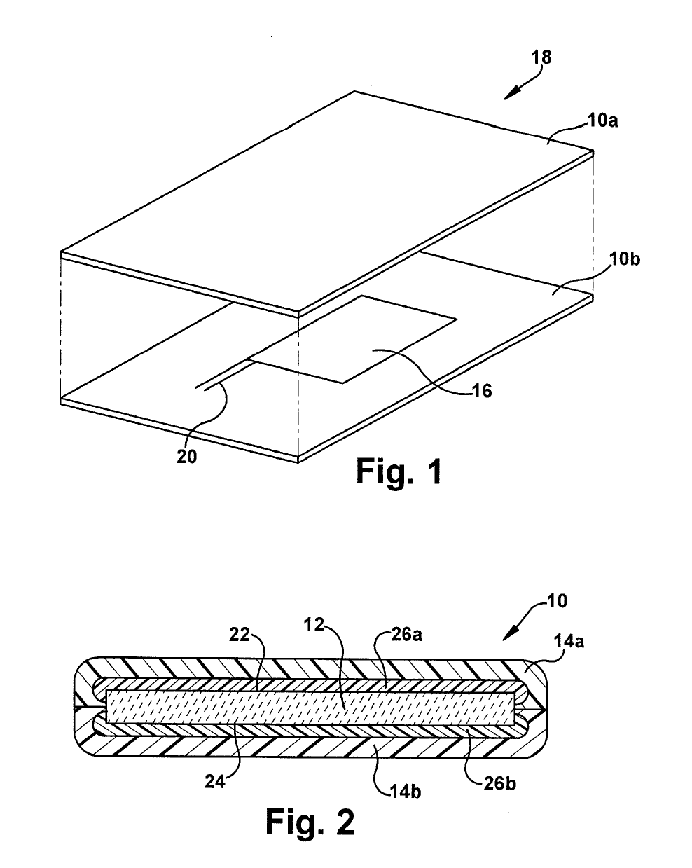

An example pressure pad system 18 is depicted in FIG. 1. The system 18 includes two pressure distribution pads 10a, 10b or pressure pads surrounding a flex heater 16 with leads 20. As discussed above, any kind of laminating component 16 can be positioned between the two pads 10a, 10b. An upper pressure pad 10a is positioned above the flex heater 16 and a lower pressure pad 10b is positioned below the flex heater 16. In operation, the pressure pads 10a, 10b could be coupled to press platens (not shown) in any known manner and the flex heater 16 is laminated when the pressure pads 10a, 10b come into contact with one another.

Referring to FIGS. 2-4, example pressure pads 10 are shown. In each example, a core layer 12 is formed by a thin sheet of graphite. The graphite layer 12 has a first lower side 22 and a second upper side 24. The first side 22 alone may be coated with a coating 14a, or both the first and second sides 22, 24 may be coated 14a, 14b. The coatings 14a, 14b may be films, fabrics, scrims, or other coatings. The coatings 14a, 14b may be liquid or solid coatings. The graphite layer 12 may have a tendency to flake, so encapsulation is often desirable in applications where contamination avoidance is necessary. The coatings 14a, 14b serve to keep the graphite flake from contaminating the work piece and environment and can also serve as a release liner, which allows the laminated material 16 to be removed without contaminating or damaging the laminate 16. Coatings 14a, 14b may include various types of rubber, Teflon, Polyimide, polypropylene, polyester, polyvinylchloride, polyester, polyethylene, thermoplastic film, and other polymer films/coatings. Fabrics and scrims 14a, 14b may include fiberglass cloth/scrim, coated fiberglass cloth/scrim (may be coated with any of the materials used for the coatings as described above), woven ceramics (including woven silica and other ceramics), coated woven ceramics, and any other fabric suitable for laminating temperatures.

The coatings or films 14 may have a thickness of 0.0005 inches to about 0.1 inches. One example range of coatings 14 is about 0.005 inches to about 0.01 inches. It is preferred that the coating be less than about 0.1 inches thick.

When coated on both sides, the graphite may be encapsulated between the two sides of coatings 14a, 14b. The coating layers 14a, 14b on either side of the graphite 12 may be the same material or a different material. The coating 14a, 14b may be used on only one side, or on both sides. For example, a plurality of pads 10a, 10b may be stacked upon each other with laminations 16 between each pair of pads 10a, 10b. It is preferred that both layers 14a, 14b on either side 22, 24 of the graphite 12 are capable of withstanding a maximum operating temperature assigned to the pad 10, although each material may itself have a different maximum operating temperature.

Multiple layers 14a, 14b, 14c may be provided on the first and second sides 22, 24 of the graphite sheet 12. For example, as shown in FIG. 2, a first coating film 14a is coupled to the graphite 12 via a first adhesive layer 26a on the first side 22 of the graphite. A second coating film 14b is coupled to the graphite 12 via a second adhesive layer 26b on the second side 24 of the graphite. The first and second films 14a, 14b are larger in surface area than the graphite 12 and mate around the edges of the graphite layer 12 to encapsulate the graphite 12. In FIG. 2, the coating layers 14a, 14b mate together without needing an adhesive. There may be instances where an adhesive layer 26 is needed in order to join the first film 14a to the second coating 14b, in which case the first or second adhesive layers 26a, 26b may be extended, or a third adhesive 26c may be utilized if desired.

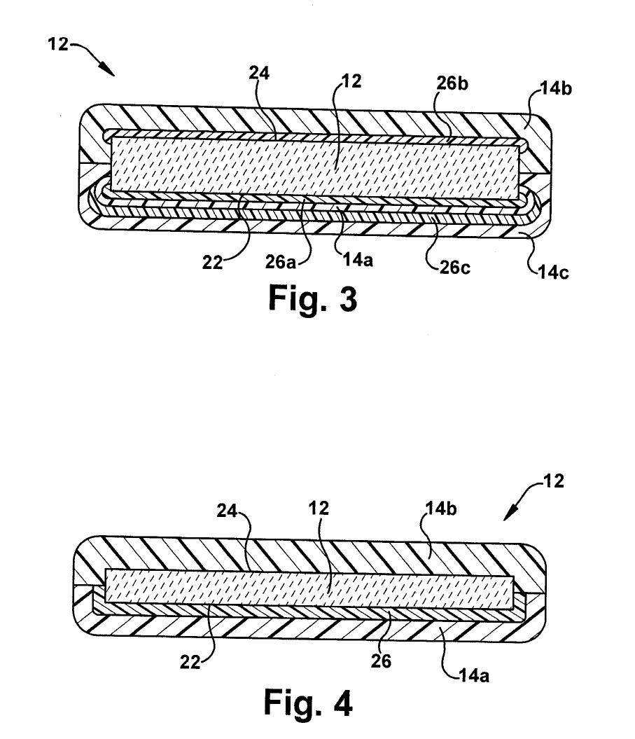

In FIG. 3, multiple layers of film or fabric/scrim 14a, 14b, 14c are shown provided on either side 22, 24 of the graphite 12. In particular, three coating layers 14a, 14b, 14c are provided. More coating layers could be provided if so desired. A first adhesive layer 26a is coupled to the first side 22 of the graphite 12 and a first coating 14a is coupled to the first adhesive 26a. A second adhesive layer 26b is coupled to the second side 24 of the graphite 12 and a second coating 14b is coupled to the second adhesive 26b. A third adhesive 26c is coupled to the first coating 14a and a third coating 14c is coupled to the third adhesive 26c. In this example, the second and third coatings 14b, 14c mate with one another at the end of the graphite sheet 12 in order to encapsulate the graphite sheet 12. The adhesive layers 26a, 26b, 26c may spill over the edges of the graphite sheet 12 in order to aid in joining the second and third layers 14b, 14c to one another. Alternatively, the second and third layers 14b, 14c may have properties that allow them to be joined without the need for an adhesive. In this example, one of the coatings may be a fabric or scrim while the other two coatings are films. The fabric layer may be the first coating 14a. The first layer of coating 14a may have a tensile strength greater than that of the third layer 14c and the graphite layer 12. Alternatively, the third layer 14c may have a tensile strength that is similar to that of the other layers. The tensile strength of the pad 10 may become important to prevent damage to the pad 10 during handling. The graphite core 12 has little tensile strength of its own, so it relies on the adjacent materials to provide tensile strength in some cases. An appropriate material on a single side of the pressure pad 10 often provides a sufficient amount of tensile strength for proper operation.

FIG. 4 depicts an alternative example pressure pad 10 where only a single layer of adhesive 26 is used to join two coatings 14a, 14b to the graphite core 12. An adhesive layer 26 is positioned on a first side 22 of the graphite core 12 and a first coating 14a is adhered to the first adhesive layer 26. A second coating 14b is positioned on the second side 24 of the graphite core 12. The first adhesive layer 26 extends past the end of the graphite core 12 and mates with the second coating 14b in order to join the first and second coatings 14a, 14b together to encapsulate the graphite core 12.

In any of the above examples, the coatings may have different tensile strengths, with the first, second, and third coatings 14a, 14b, 14c having different tensile strengths than one another. Alternatively, the coatings may all have the same tensile strength. The coatings may all be the same material or may be different materials, as desired.

The adhesive layer 26, 26a, 26b, 26c is preferably a pressure sensitive adhesive in either liquid or film form. Examples of such adhesives include thermoplastic or thermoset film adhesives and epoxies. The adhesive may comprise a fluoropolymer adhesive, a thermoplastic adhesive, or other types of adhesive. Examples are envisioned where an adhesive layer 26, 26a, 26b, 26c is only necessary on one side of the pressure pad 10.

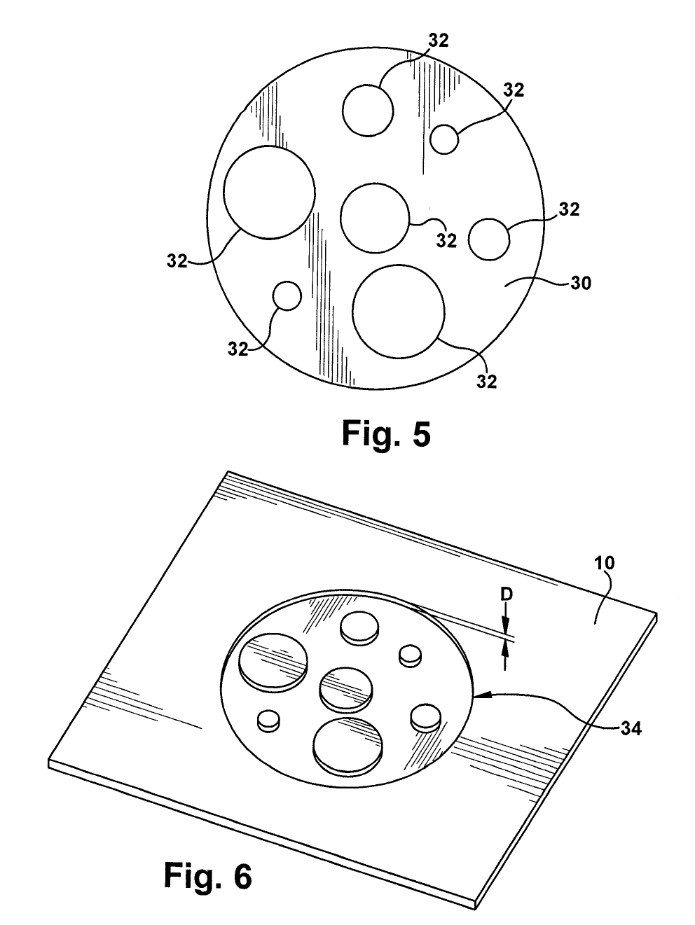

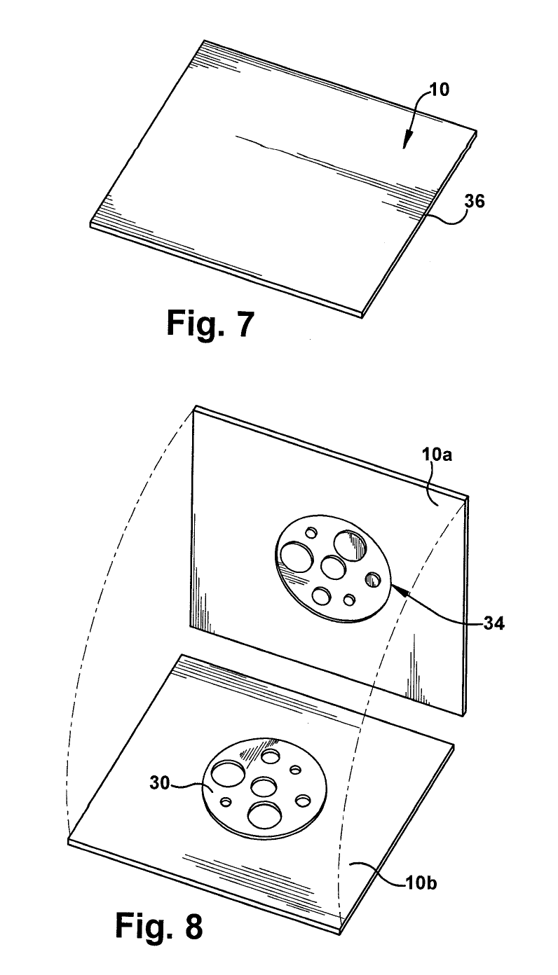

Each pressure pad 10 may be designed for a single use or for multiple uses. The graphite 12 will generally deform based upon the surface features of the laminate. FIG. 5 depicts a paper test shape 30 having a thickness of 0.004 inches (0.01 mm). The test shape 30 has holes 32 that simulate features on a laminate 16. The paper shape 30 is used to illustrate any variety of laminates 16 that may be constructed utilizing the present pressure pads 10. FIG. 6 depicts the impression 34 the test shape 30 leaves in the pressure pad 10. FIG. 7 depicts a pressure pad 10 before being used. FIG. 8 depicts the test shape 30 positioned between two pressure pads 10a, 10b and the impression 34 left on the upper pad 10a. The impression 34 has an approximate depth of 0.001 inches (0.025 mm). The impression 34 of the test shape 30 is left on both the upper pressure pad 10a and the lower pressure pad 10b. In other usages, the shape of the laminate 16 may not be impressed into the graphite layers 12.

As is evident from the test shape impression 34, if a laminate is being processed that has multiple surface features, it may be preferred to used the pressure pad 10 only once. In the example shown in FIG. 6, the pressure pad 10 deforms approximately 0.001 inches (0.025 mm) based upon the applied pressure. The pad 10 could be reused on a similar test part 30 by applying a greater amount of pressure so that the pressure pad 10 deforms another 0.001 inches (0.025 mm) with the second use, so that the total deformation of the pressure pad 10 would then be 0.002 inches (0.051 mm). This may be repeated for greater pressures. This is accomplished by varying the pressure such that greater depths are achieved for subsequent parts. As a result, the pads 10 may be used multiple times. However, it is readily recognized that the pads 10 may only be used once in certain situations, and this is dictated by the manufacturer as well as the materials being laminated. Where laminates 16 are being processed that have little or no surface features, the pads 10 may more easily be used multiple times. As previously discussed, both sides of the pad 10 (e.g. upper and lower surfaces) may be used, if desired. Other reuse scenarios are also readily evident to those of skill in the art and are incorporated herein.

The pressure pads 10 may be placed on one or both sides of a laminate 16. The pads 10 compress in order to provide uniform pressure and quicker time to temperature to the laminate. The pressure pads 10 may be attached to platens or passed through press rollers. The pressure pads 10 fill gaps in laminates or compress to compensate for imperfections or uneven clamping of the press or rollers. Pressure pads 10 may be stacked upon one another or provide sufficient compression.

The graphite core 12 can be made from flexible graphite with densities ranging from about 30 lbs/ft³ to 110 lbs/ft³. The density may alternatively range between 50 lbs/ft³ and 90 lbs/ft³, or 50 lbs/ft³ and 70 lbs/ft³. Grade, thickness, and density of the graphite core 12 are chosen based mainly on the laminating pressure, and laminate thickness differential. One range of graphite thickness that may be used with the example pressure pad 10 is 0.005 inches to 0.25 inches, but thicknesses could be as great as 1 inch. Other factors can also be considered when choosing the core material, including, but not limited to, reusability, surface texture requirements, and other requirements. The graphite core 12 compresses and conforms to irregular surfaces and ensures even lamination in areas with less thickness. The thermal conductivity of the flexible graphite ensures that the temperature distribution is uniform allowing the adhesive or resin to cure/melt evenly. No in-plane movement of components/traces should occur because the graphite core 12 has little to no creep at laminating temperatures and pressures. An example graphite layer that may be utilized is the SIGRAFLEX™ flexible graphite foil produced by SGL Technologies of Weisbaden, Germany.

Films and coatings 14a, 14b are selected based on the customer's process temperature, amount of compression/conformability required, required surface finish, cost, and other factors. Scrim or fabric may need to be added, in some cases, to increase the tensile strength of the pressure pad 10.

The example pressure pads 10 are often seated on platens within a press. The deformability of the graphite layer 12 also assists in promoting uniformity to the laminate in situations where the platen may be pitted. The pressure pads 10 may be any desired shape and size. Example square pressure pads 10 may range in size from 3″×3″ up to 60″×60″. Other sizes and shapes are also possible with the above-described examples.

### EXAMPLES

The following examples use flexible graphite with a density of 50 lbs. per cubic foot and a thickness of 0.030 inches (0.76 mm). C grade graphite material is beneficial because it is slightly more compressible due to its higher ash content when compared to grades A and B. Grade C material is also preferred because it is less costly. However, grades A and B could be used in certain circumstances.

In Example 1, a 0.030 inches (0.76 mm) thick Grade C flexible graphite sheet 12 with a density of 50 lbs/ft³ is laminated to a 0.002 inches (0.05 mm) thick PTFE film 14. This combination yields excellent results when laminating at moderately high temperatures (<500° F. (260° C.)). The non-stick PTFE coating 26 is useful when laminating materials that become sticky or tacky at elevated temperatures.

In Example 2, a 0.030 inches (0.76 mm) thick Grade C flexible graphite sheet 12 with a density of 50 lbs/ft³ is laminated to a 0.003 inches (0.076 mm) thick PTFE coated fiberglass 14. This combination has all of the non-stick benefits of Example #1, but is more durable and gives the finished work piece a textured appearance because of the addition of the fiberglass weave. The textured finish may also be a benefit if the laminate is to be used in conjunction with adhesives or epoxies. A textured finish will usually provide stronger bonds than a smooth finish will.

In Example 3, a 0.030 inches (0.76 mm) thick Grade C flexible graphite sheet with a density of 50 lbs/ft³ is laminated to 0.001 inches (0.025 mm) thick polyimide film (outer layer) 14 with a 0.001 inches (0.025 mm) thick FEP or PFA film (adhesive layer) 26. This pressure pad 10 is suitable for temperatures up to 600° F. and is an excellent choice when laminating with adhesives activated/cured at high temperatures.

In Example 4, a 0.030 inches (0.76 mm) thick Grade C flexible graphite sheet with a density of 50 lbs/ft³ laminated to a 0.001 inches (0.025 mm) thick polyimide film (outer layer) 14. This pressure pad 10 is suitable for temperatures up to 725° F. and is an excellent choice when laminating with adhesives that are activated/cured at high temperatures. This pressure pad 10 is not sealed at the edges like the previous three examples may be. This may be undesirable to some users because of the potential for contamination.

In Example 5, a 0.030 inches (0.76 mm) thick Grade C flexible graphite sheet with a density of 50 lbs/ft³ laminated to a 0.001 inches (0.025 mm) thick polyimide film 14a via a 0.002 inches (0.05 mm) thick pressure sensitive silicon adhesive 26 on a first side 22 and a 0.001 (0.025 mm) thick polyimide film 14b on the second side 24. The polyimide film and adhesive on the first side 22 are larger in dimension than the graphite sheet 12 such that an edge of adhesive 26 sticks out past the edge of the graphite. The polyimide film on the second side 24 attaches to the adhesive 26 on the first side to encapsulate the graphite 12. This example is depicted in FIG. 4.

Many other combinations of materials are possible and the selection of materials is driven by the application. Graphite thickness, density, and grade may vary. Favored materials include Teflon coated fiberglass, polyimide films, and silicone coated fabric. Material thicknesses depicted in the figures may be exaggerated or understated.

A method for laminating includes providing a first and a second pressure pad 10a, 10b as described above, positioning a laminate 16 between the first and second pressure pads 10a, 10b, and pressing the pads 10a, 10b together while heating. The pads 10a, 10b may be pressed together by a press or by traveling through rollers. Other methods for laminating utilizing the herein described pressure pads 10 are also anticipated.

A pressure distribution pad for use in laminating applications comprises a flexible layer of graphite and a first layer of at least one of a coating, film, fabric and scrim coupled to the layer of graphite. The flexible graphite layer may ranges in thickness from about 0.005 inches (0.127 mm) to 0.25 inches (6.35 mm). The flexible graphite layer is the core of the pad and the first layer is coupled to one side of the core. A second layer of at least one of a coating, film, fabric and scrim may be coupled to the other side of the core. A first adhesive layer may be positioned between the core and the first layer and a second adhesive layer may be positioned between the core and the second layer.

The pad may further comprise a third layer of at least one of a coating, film, fabric; and a third adhesive layer. The third adhesive layer may be is positioned adjacent the core and the third layer may be positioned adjacent the third adhesive layer. The first adhesive layer may be positioned adjacent the third layer and the first layer may be positioned adjacent the first adhesive layer.

The first and second layers each have thermal properties. The first and second layers may be made of a first and a second material that are different from one another. The pad has a temperature maximum and the first and second different materials have thermal properties that allow them to withstand temperatures at or above the temperature maximum of the pad.

The first and second layers may be coupled to the core by at least one of laminating and coating, The first layer may be coupled to the flexible layer of graphite via a first adhesive layer. The flexible layer of graphite may have a density ranging from about 30 lbs/ft³ to 110 lbs/ft³. Alternatively, the flexible layer of graphite may have a density ranging from 50 lbs/ft³ to 90 lbs/ft³. Alternatively, the flexible layer of graphite may have a density ranging from 50 lbs/ft³ to 70 lbs/ft³. The coating may be one or more of a rubber, Teflon, polyimide, polypropylene, polyester, polyvinylchloride, polyester, and polyethylene. The first layer may be a release liner. The first layer may be a thermoplastic film and the first adhesive may be a fluoropolymer adhesive. The first layer may be a polyimide film and the first adhesive may be a thermoplastic adhesive. The first layer may have a tensile strength greater than that of the third layer and the graphite layer.

The pad may further comprise a first adhesive layer positioned between the first layer and the graphite layer on a first side of the graphite layer and a second layer of at least one of a coating, film, fabric and scrim coupled to the second side of the layer of graphite. The first adhesive layer may extend past the boundaries of the graphite layer to couple with the second layer.

While various features of the claimed embodiments are presented above, it should be understood that the features may be used singly or in any combination thereof. Therefore, the claimed embodiments are not to be limited to only the specific embodiments depicted herein.

Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A pressure distribution pad for use in laminating applications comprising:
a flexible layer of graphite; and
a first layer of at least one of a coating, film, fabric and scrim coupled to the layer of graphite.

2. The pressure distribution pad of claim 1, wherein the flexible graphite layer ranges in thickness from about 0.005 inches (0.127 mm) to 0.25 inches (6.35 mm).

3. The pressure distribution pad of claim 1, wherein the flexible graphite layer is the core of the pad and the first layer is coupled to one side of the core and a second layer of at least one of a coating, film, fabric and scrim is coupled to the other side of the core.

4. The pressure distribution pad of claim 3, further comprising a first adhesive layer positioned between the core and the first layer and a second adhesive layer positioned between the core and the second layer.

5. The pressure distribution pad of claim 4, further comprising a third layer of at least one of a coating, film, fabric; and a third adhesive layer, wherein the third adhesive layer is positioned adjacent the core, the third layer is positioned adjacent the third adhesive layer; the first adhesive layer is positioned adjacent the third layer, and the first layer is positioned adjacent the first adhesive layer.

6. The pressure distribution pad of claim 3, wherein the first and second layers each have thermal properties; the first and second layers are made of a first and a second material that are different from one another; the pad has a temperature maximum; and the first and second different materials having thermal properties that allow them to withstand temperatures at or above the temperature maximum of the pad.

7. The pressure distribution pad of claim 3, wherein the first and second layers are coupled to the core by at least one of laminating and coating.

8. The pressure distribution pad of claim 1, wherein the first layer is coupled to the flexible layer of graphite via a first adhesive layer.

9. The pressure distribution pad of claim 1, wherein the flexible layer of graphite has a density ranging from about 30 lbs/ft³ to 110 lbs/ft³.

10. The pressure distribution pad of claim 1, wherein the flexible layer of graphite has a density ranging from 50 lbs/ft³ to 90 lbs/ft³.

11. The pressure distribution pad of claim 1, wherein the flexible layer of graphite has a density ranging from 50 lbs/ft³ to 70 lbs/ft³.

12. The pressure distribution pad of claim 1, wherein the coating is one or more of a rubber, Teflon, polyimide, polypropylene, polyester polyvinylchloride, polyester, and polyethylene.

13. The pressure distribution pad of claim 1, wherein the first layer is a release liner.

14. The pressure distribution pad of claim 8, wherein the first layer is a thermoplastic film and the first adhesive is a fluoropolymer adhesive.

15. The pressure distribution pad of claim 8, wherein the first layer is a polyimide film and the first adhesive is a thermoplastic adhesive.

16. The pressure distribution pad of claim 5, wherein the first layer has a tensile strength greater than that of the third layer and the graphite layer.

17. The pressure distribution pad of claim 1, further comprising a first adhesive layer positioned between the first layer and the graphite layer on a first side of the graphite layer and a second layer of at least one of a coating, film, fabric and scrim coupled to the second side of the layer of graphite, wherein the first adhesive layer extends past the boundaries of the graphite layer to couple with the second layer.
